(19) United States
(12) Patent Application Publication
(10) Pub. No.: US 2003/0171969 A1
(43) Pub. Date: Sep. 11, 2003

(54) System and method for real-time management of business activities

(76) Inventors: Raymond Morin, Saint Georges (CA); Denis Doyon, Saint Georges (CA); Raouf Manneh, Saint Georges (CA)

Correspondence Address: DARBY & DARBY P.C., P. O. BOX 5257, NEW YORK, NY, 10150-5257, US

(21) Appl. No.: 10/312,454

(22) PCT Filed: Jun. 27, 2001
(86) PCT No.: PCT/CA01/00952

(30) Foreign Application Priority Data
Jun. 27, 2000 (CA) 2312656

(51) Int. Cl. G06F 17/60

(52) U.S. Cl. 705/8

(57) ABSTRACT

A system and method for real-time management of business activities is described herein. The system includes a server computer, a business database and a user database. The business database includes records, each characterizing a business activity and including data entries. The system allows registered users to log to the server via a personal remote computer, submit new data entries and visualize personalized control and operating panels. The method includes validating the new data entry submitted by a user, updating in cascade all records of the business database that are affected by the new data entry and updated the control and operating panels of all users logged to the system. The control panel allows to visualize alarms according to user-defined criteria, while the operating panel allows to visualize updated information about selected business activities.

### FIELD OF THE INVENTION

The present invention relates to accounting management. More specifically, the present invention is concerned with a system and method for real-time management of business activities.

### BACKGROUND OF THE INVENTION

Turning to FIG. 1 of the appended drawings, which is labelled prior art, a conventional method 10 for managing business activities will be described.

According to the conventional method 10, each of a plurality of journals 12 keeps track of a business activity 14. Traditionally, when a new transaction occurs in one of these activities 14, a transaction entry describing the new transaction is entered in the corresponding journal 12.

Periodically, the new transactions are transferred 16 into a ledger 18, sometimes incorporating data entries from a general journal 20 that include end of period adjustments 22.

At the end of a longer period 24, the accounting entries from the ledger are used to prepare financial statements 26.

Since this conventional method of managing business activities is believed to be well known in the art, it will not be described herein in further detail.

Obviously, all the above-mentioned operations have long been executed by hand.

However, since the introduction of the first commercial mainframe computers, there have been accounting systems to store and perform the above-described accounting transactions. These systems were generally designed to collect and store data related to accounting transactions 14 in journals in the form of computer databases.

Although those early systems were considered an improvement over some aspects of conventional manual processing, their still relatively slow processing speed and their unreliability prevented direct (or “live”) and thorough updates of the business databases. Complete management of business activities is impossible with these systems.

With the increasing processing speed of computer systems and their ease of use, arose computer based accounting systems that allow live modification of the accounting databases.

An example of such computer based accounting systems is described in U.S. Pat. No. 5,117,356, issued to Marks on May 26, 1992 and entitled “Automated Ledger Account Maintenance System”.

Mark's system allows to first, transfer transaction data from a data input means to a selected transaction record in a database, and then to a ledger account record. The system further includes a means to ensure that a new data transaction is correctly added and that the corresponding record is correctly updated.

However, a first drawback of such systems from the prior art is that they only allow direct posting of the transaction data in the ledger. They do not anticipate the update in cascade of records resulting from the transaction data. Therefore, it is not possible to obtain real-time financial statements with systems from the prior art.

It is to be noted that the expression “real-time information” is used herein to refer to information that is updated and that is representative of all transactions performed up to the moment the information is requested.

Another drawback of systems from the prior art is that they do not include any interface for real-time monitoring of the transactions or of the record's content, nor the trigger of alarm if the transactions or record content correspond to predetermined criteria.

Finally, no known computer based accounting system from the prior art is able to produce a financial estimate using real-time data.

### SUMMARY OF THE INVENTION

More specifically, in accordance with the present invention, there is provided a system for real-time management of business activities, the system comprising:

a business database including records; each of the records characterizing a business activity and including data entries; at least one of the records affecting at least one other of the records; and

a controller so configured as to:

a) receive a submission for a new data entry;

b) validate the new data entry, including associating the new data entry to a related record in the business database;

c) update each of the records that are affected by the related record; and

d) recursively repeat step c) for each of the affected records.

According to another aspect of the present invention, there is provided a method in a computer system for real-time management of business activities, the method comprising:

providing a business database including records; each of the records characterizing a business activity and including data entries related to the business activity; at least one of the records affecting at least one other of the records; and

when a new data entry is submitted by a registered user,

a) validating the new data entry, including associating the new data entry to a related record in the business database;

b) updating each the record that are affected by the related record; and

c) recursively repeating step b) for each of the affected records;

whereby, each record that are directly or indirectly affected by another record are updated when a data entry is added in the other record.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1, which is labelled prior art, is a block diagram illustrating a conventional manual method for managing accounts;

FIG. 2 is a block diagram of a system for real-time management of business activities according to an embodiment of the present invention;

FIG. 3 is a schematic view illustrating the business database from the system of FIG. 2;

FIG. 4 is a schematic view illustrating a control panel according to an embodiment of the present invention;

FIG. 5 is a flowchart illustrating a method for real-time management of business activities according to an embodiment of the present invention;

FIG. 6 is a flowchart illustrating the validation step of FIG. 5; and

FIG. 7 is a block diagram illustrating the operation of the system of FIG. 1.

### DESCRIPTION OF THE PREFERRED EMBODIMENT

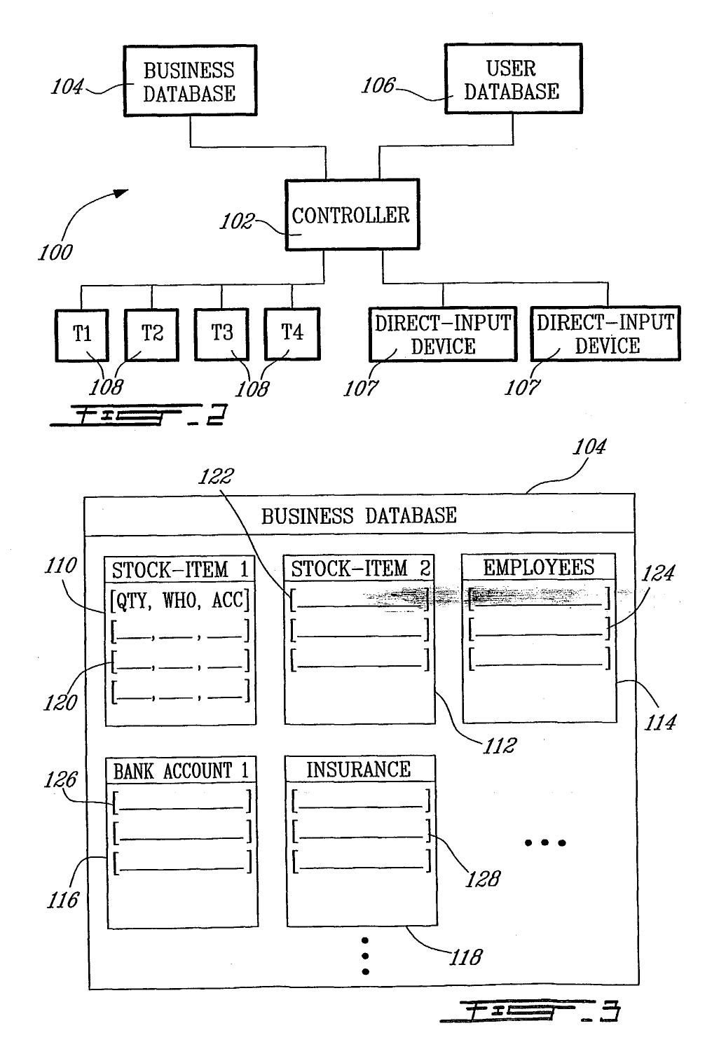

Turning now to FIG. 2 of the appended drawings, a system 100 for real-time management of business activities, according to an embodiment of the present invention, will be described.

The system 100 comprises a controller 102, a business database 104, a user database 106, direct-input devices 107 (two in this example), and a plurality of terminals 108 (four in this example), labelled T1 to T4.

The controller 102 is advantageously in the form of a server computer. Alternatively, the controller 102 may take other forms, such as a laptop computer and a mainframe computer.

As will be described in further detail hereinbelow, the controller 102 is configured so as to embody a method for real-time management of business according to the present invention.

The controller 102 is also configured to allow connection of one or more direct-input devices 107, and one or more terminals 108 thereto.

Other features of the controller 102 will become more apparent on reading the following description.

The direct-input devices 107, terminals 108 and the controller 102 are advantageously part of a computer network and communicate using a conventional network protocol, such as NetBIOS (Network Basic Input/Output System) or TCP/IP (Transfer Call Protocol/lnternet Protocol).

Some or all of the direct-input devices 107 and terminals 108 may also be remotely connected via a computer network such as the Internet or via a dial-up service supported by the server 102.

The direct-input devices 107 may take many forms such as a bar-code scanner, a photovoltaic detector, an automatic control system, etc.

The direct-input devices 107 allow automatically gathering information about predetermined business activities with no or minimum intervention from an operator. For example, a bar code scanner (not shown) may allow to keep track of stocks.

The terminals 108 are advantageously in the form of personal computers connected to the controller 102. Of course, each of the terminals 108 include conventional input and output devices.

Since network architecture is believed to be well known in the art, it will not be described herein in further detail.

Optionally, some of the terminals 108 may be equipped with a device similar to the direct-input devices 107 to input information about a business activity in the system 100.

As will be explained hereinbelow in more detail, since the function of the direct-input devices 107 and of the terminals 108 are similarly to submit data entries in the business database 104, and for concision purposes, the reference to terminals 108 will intend to include also direct-input devices 107, unless otherwise specified.

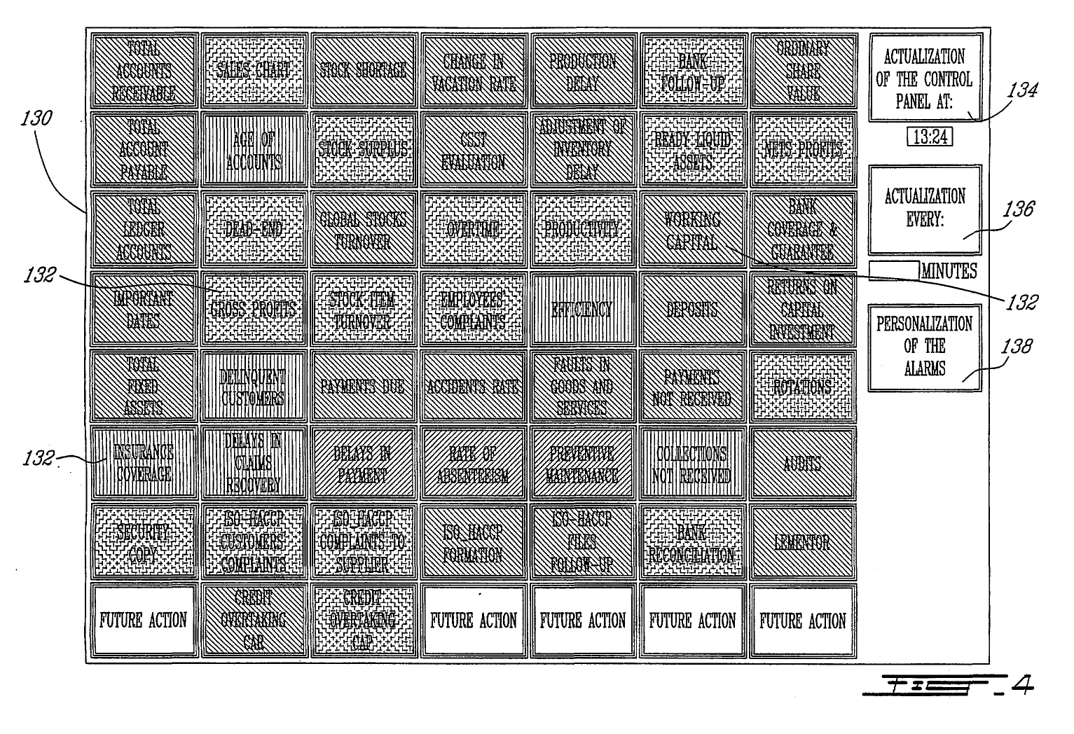

As can be seen in FIG. 3, the business database 104 includes a plurality of records 110-118, each characterizing a business activity. Each record 110-118 includes data entries 120-128 characterizing a transaction and/or a changeover time of a business activity. Moreover, some of the records 110-118 may also include links to other records 110-118 that may be affected by data entries in the affecting record.

For example, the record 110 represents the stock of item 1 that is offered for sale. The data entries 120 of this record 110 are indicative of the quantity (QTY) of items that is added or removed from the stock. They are also indicative of the date of change in stock, the name and/or account number of the provider or buyer of the item for that particular transaction, and the bank account (represented by another record) that will be affected by the purchase or sale of the stock.

In this example, the STOCK-ITEM 1 record 110 includes a link to the records representing the bank account of the enterprise that may be affected by the transaction corresponding to data entries 120.

It is to be noted that almost any qualitative or quantitative (or both) business activity may be represented in the form of a record in the business database 104. Examples of business activities that may be represented as a record in the business database 104, and therefore managed by the system 100 include: stocks, bank accounts, insurance, employee-related information, sales, employee complaints, security issues, etc.

Also meta-records may be created by compiling some of the information contained in one or more records.

Of course, the number of records, their size and the number and type of data entries in the business database 104 may vary without departing from the spirit and nature of the present invention.

The system 100 also advantageously includes a user database 106. The user database 106 includes information related to registered and authorized users who are allowed to connect to the system 100 via one of the remote terminals 108. More specifically, the user database 106 includes information related to user accounts.

This information includes user names and passwords of users that are authorized to connect to the system 100 via a terminal 108. The user database 106 also includes the preferences of each registered user. These preferences allow for personalization of the interface which is provided by the controller 102 to the user on the terminal 108 to which the user is connected.

Other features and advantages of the user database 106 will become more apparent on reading the following description.

The business and user databases 104-106 are advantageously stored in a storing means (not shown) connected to the server 102.

According to a preferred embodiment of the present invention, the business and user databases 104-106 are stored in a hard disk drive (not shown) part of to the controller 102.

Of course, the storing means may take many forms. For example, Random Access Memory (RAM) and flash memory may also be used.

Optionally, a backup copy of the business database 104 may be done and stored using conventional means.

The business and user databases 104-106 are advantageously connected to the controller 102 so as to allow fast access to the databases 104-106.

Alternatively, the business and user databases 104-106 may be part of a secondary controller so remotely connected to the controller 102 as to be accessed via a computer network.

Conventional database tools, structure and manager, such as Microsoft™ Access™ or Oracle™, may be used to create the business database 104 and/or user database 106.

Alternatively, the business and user databases 104 and 106 may be merged in a single database including records related to both the business and the user. Also, each database 104 or 106 may be composed of a plurality of databases. In this case, each of the plurality of databases may be in a different location and may be independently coupled to the controller 102. Of course, the controller 102 would be configured so as to locate the database that includes a specific record 110-118. A conventional allocation table (not shown) may be used for that purpose.

Upon request by a registered user, the controller 102 is advantageously configured so as to display a control panel 130 (FIG. 4) or an operating panel 140 (FIG. 7) on the terminal 108 of this particular user.

FIG. 4 illustrates a control panel 130 according to an embodiment of the present invention.

The control panel 130 includes a plurality of display fields 132, each display field 132 corresponding to a business activity and to control buttons 134-138.

As will become apparent upon reading the following paragraphs, the control panel 130 allows for the display of alarm messages to each registered user about user-selected business activities according to predetermined criteria.

A business activity to be monitored may be assigned to one of the display field. A dedicated control button 138 may be used to initiate the personalization process of the control panel 130. The user, who has been previously identified to the system via its user name and has been authorized via its password, is advantageously offered a list of business activities among those managed by the system 100 and to which records correspond in the business database 104. It may also be advantageous to monitore meta-activities through the control panel 130.

A registered user may predetermine alarm criteria for all selected business activities that he may want to monitor. This predetermined criteria is advantageously stored in the user database 106 so as to be active each time the user activates his control panel 130 via its terminal 108.

The controller 102 is advantageously configured so as to provide the user with graphic tools on its terminal 108, easing the entry and selection of the alarm criteria.

The controller 102 may be configured to display information indicative of the corresponding alarm triggering criteria on the corresponding user's terminal.

This criteria may take various forms, depending on the user's preferences and the business activity, for example, a user may define different “safety” ranges for a selected business activity. Each range may be associated with a color code similar to conventional traffic lights. Indeed, the display field of the activity will be green if an entry in the corresponding record is below a first value. The display field will appear yellow if an entry is between the first value and a second value. Finally, the display field will be red if an entry in the record is beyond a safety limit predetermined by the user.

The representation of the alarm may also take different forms, such as for example, differences in the display field shapes, sound signals, etc.

An alarm may also be triggered when any data entry in a record corresponds to a predetermined value or when the number of data entries reach a certain limit.

Obviously, the controller 102 may be configured so as to verify if different data entries correspond to different criteria without departing from the spirit and nature of the present invention. Also, the controller 102 may be configured so as to display other visual representations of the corresponding alarms.

Other control buttons 134 and 136 offer the user the possibility to update the control panel display fields 132 respectively at a certain time of the day, or at fixed period of time. Indeed, as will be explained hereinbelow, the system and method of managing business activities, according to the present invention, provides real-time updates of all the records in the business database 104, and therefore of all managed business activities.

A control panel according to the present invention is advantageous since it allows visual warnings, at a glance, of business activities that are of interest or are his responsibility.

Alternatively, the alarm criteria and/or the business activities displayed on the control panel may be the same for all users.

The list of business activities, update preferences and the alarm criteria chosen by the user are advantageously stored on the user database 104, so as to render the personalized control panel readily available to a user upon logging into the system 100 via any of the terminals 108.

The operating panel 140 allows visualization of business activities by displaying data entries in user-selected records of the database. Similarly to the control panel, the operating panel 140 is personalized.

The operating panel 140 allows, for example, visualization of the time-variation of selected business activities. Of course, the time range for every business activity, the actualization time of the displayed data and the form of the data presentation may vary and are stored in the user database 106.

For example, the time-variation of values in a record may be represented by a line chart, a pie chart or a bar chart.

The controller 102 is advantageously configured so as to display operating panels 140 that simultaneously shows time-variations of a plurality of records from the business database 104. The operating panel 140 is therefore advantageously configurable so as to include windows, each containing a graphical representation of the time variation, during a selected period, of a business activity.

A user interface, including a user menu, allows the user to select business activity to monitored, to re-arrange the windows, to select a time period, and, similarly to the control panel 130, to select an update time or period.

Alternatively or additionally, the operating panel 140 may display information about the business activities other than time-variation. For example, a list of absent employees may be updated by the system 100, as will be explained hereinbelow, and displayed on the operating panel 140.

Examples of information that may be displayed on the operating panel include: task follow-up, sales, profits before taxes, fixed charge evolution, list of late payments, etc.

The system 100 may be configured so as to simultaneously manage business activities from a plurality of society. In this case, different user preferences may be determined for different societies.

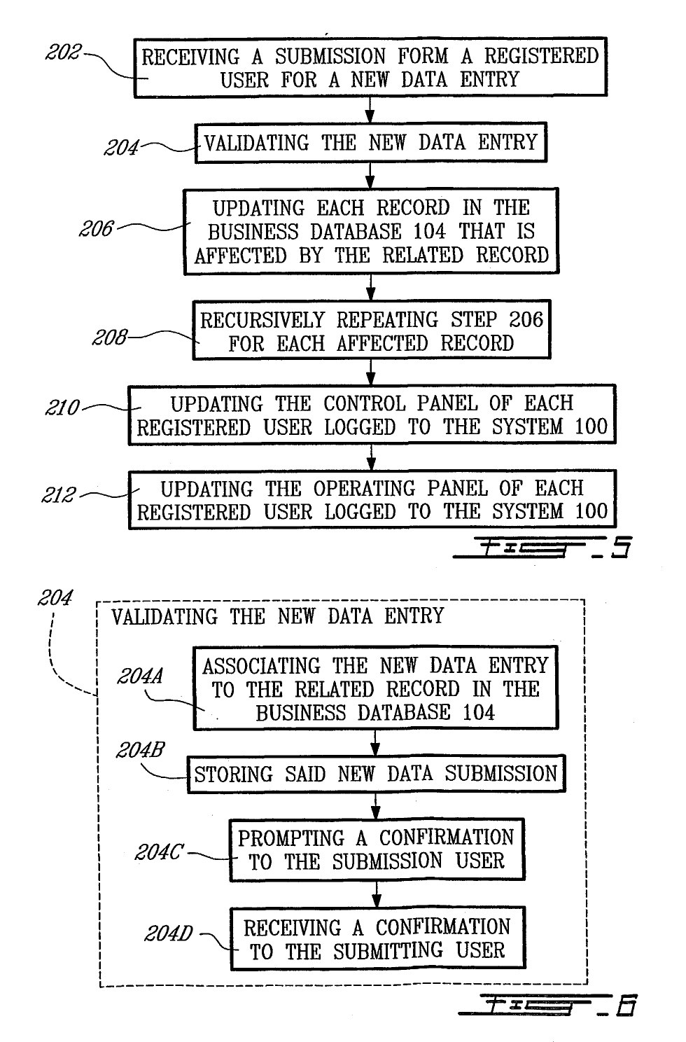

Turning now to FIG. 5, a method 200 for real-time management of business activities, according to an embodiment of the present invention, will be described.

Generally stated, the method 200 comprises the following steps, thus providing a business database 104 as described herein:

202—receiving a submission from a registered user for a new data entry;

204—validating the new data entry;

206—updating each record in the business database 104 that is affected by the related record;

208—recursively repeating step 206 for each affected record;

210—updating the control panel of each registered user logged into the system 100; and

212—updating the operating panel of each registered user logged into the system 100.

In step 202, a registered user logged into the system 100 via a terminal submits a new data entry into the business database 104. The controller 102 is configured so as to provide a user interface (not shown) requesting the related information. This user interface may be in the form of a conventional interactive menu that allows the user to select the business activities related to the data entry to be submitted. Alternatively, or depending on the nature of the related business activity, the user interface may be in the form of a replica of a form report. Of course, the user interface may take many other forms.

The controller 102 and some of the terminals 108 may be configured so as to allow submitting data entries via ASP (Active Server Page) mode. Since the ASP mode is believed to be well known in the art, it will not be described herein in more detail.

In step 204, the data entry submission is validated.

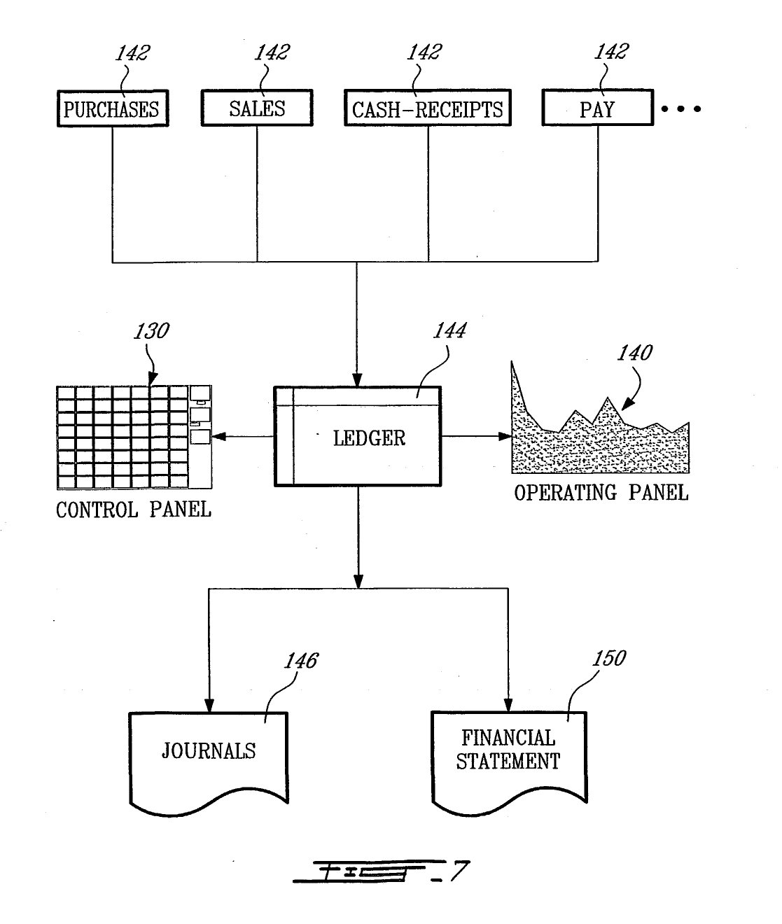

Now turning briefly to FIG. 6, step 204 includes the following sub-steps:

204A—associating the new data entry to the related record in the business database 104;

204B—storing the new data submission;

204C—prompting a confirmation to the submitting user; and

204D—receiving a confirmation from the submitting user.

It is to be noted first that, except for sub-steps 204C and 204D, that have to be performed sequentially, these sub-steps may be performed in any sequence.

In 204A, the controller 102 uses the information provided by the user in step 202 to associate the new data entry to its related record. It is to be noted that this sub-step 204A does not require any storing other then in the volatile RAM memory of the controller 102. No writing is done at this point in the actual business database 104.

However, in step 204B, the submitted data entry is temporarily stored in a non-volatile memory of the controller 102. This memory may be in any form that is non-volatile in case of a power shutdown or malfunction of the system 100. For example, this non-volatile memory may be in the form of a hard disk (not shown).

Step 204B is advantageous since it prevents the loss of data in the case of a power failure or any interruption of the system 102 between the submission of the new data entry 202 and its storage in the business database 104.

The control panel 130 may be configured so as to provide an alarm to a predetermined user(s) following a malfunction or interruption of the system 100. It has been found to be advantageous to provide an alarm specifically to the user who submitted the data entry.

The system 102 is advantageously configured so as to maintain an entry log containing all modifications on the business database 104. The entries may be characterized by the author of the entry and the date and-time.

A confirmation of the validity of the submission is then optionally requested (step 204C). This confirmation allows the user to review the data entry and to make changes.

Optionally, a confirmation may be requested from a user other than the one submitting the data entry. Such different user may be responsible, for example, for the business activity record related to the data entry.

In step 204D, the user confirms that the submitted data entry is ready to be written in the business database 104.

Depending on the nature of the business activity related to the new data entry, it may be possible to configure the controller 102 so as to verify the relevance and integrity of the data entry before it is written in the business database 104. More specifically, depending on the nature of the data entry, the controller 102 may be configured to verify if all related accounts balance before entering the value in the database 104.

Returning to FIG. 5, step 206 consists in the updating of each record in the business database 104 which is affected by the record that includes the new data entry. Indeed, as explained hereinabove, some of the records in the database 104 may include links to other records in the business database 104.

The method 200 also allows multi-references in the business database 104, i.e. that some data entries in some records may affect other entries in other records, and in turn, those affected records may affect other records.

Therefore, in step 208, step 206 is recursively repeated for each affected record. This causes a cascade-like update of the business database 104.

It is to be noted that the business database 104 is so designed as to prevent circular references, and to therefore yield an infinite loop while updating the records after a new data entry.

In steps 210 and 212, the control and operating panels 130 of all users logged into the system 100 are updated according to the user's preferences, as discussed hereinabove.

As it is conventionally known in the art, the updates of the control panels 130 and of the operating panels 140 are preferably performed in the memory and/or in the user database 106, so that the changes are reflected on the user's terminal 108 when a user activates one of these panels.

The control panels 130 and/or operating panels 140 may be displayed on the terminals using any known methods in the art. For example, the terminals may include a dedicated computer program. Alternatively, the panels 130 and/or 140 may be displayed via a well known in the art active desktop mode.

Turning now to FIG. 7, the operation of the system 100 will now be briefly described by reference to accounting transactions.

When a data entry is submitted by a user, following an actual transaction related to one of the business activities 142, and that entry is validated, it is immediately transmitted to the business database 104. Some of the records 110-118 of the business database 104 are related to a ledger 144, which is thus updated immediately by the controller 102 following the entry of the data in the business database 104.

All the control and operating panels 130 and 140 of the registered users are then also updated by the controller 102, according to the preferences of such user, as found is the user database 106.

Since the ledger 144 is updated following each data entry by a user, journals 146 and financial statements 150 may be produced by the controller at any time, following a request by an authorized user. Those journals 146 and financial statement 150 will advantageously be indicative of any new entry in the database and therefore of any business transactions.

Optionally, the controller 102 may also be configured so as to provide a perpetual budget or business forecast.

Indeed, since the business database 104 reflects, at any time, the actual status of the business activities that are managed by the system or method according to the present invention, the data entries in the business database 104 may be used at any time to prepare a budget or forecast using actual updated business data.

Using predetermined desired results on selected business activities, as provided by one of the registered users, the controller 102 may also alternatively compute results that should be achieved in other business activities, in order to achieve the desired results.

Obviously, the system 100 is advantageously configured so as to allow adding new records in the business or user databases 104 and 106.

As will now be apparent to a person skilled in the art, the method and system according to embodiments of the present invention allow obtaining data and results related to selected business activities that reflect last minute changes in the business database 104, and therefore in the society managed by such a system and method.

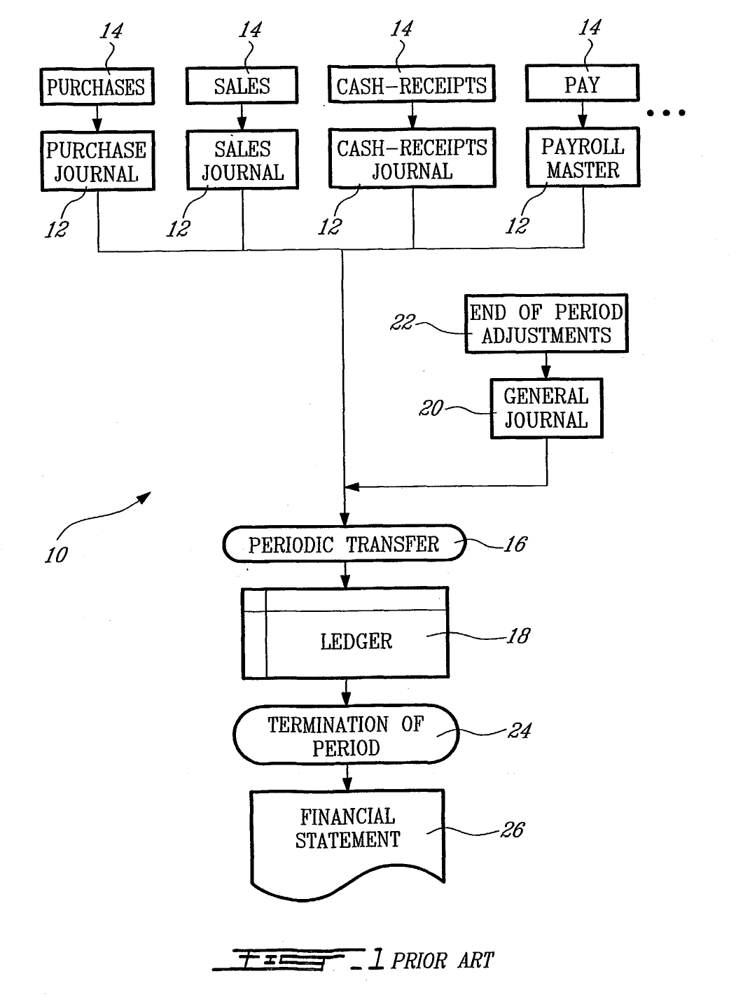

Moreover, the system and method of the present invention renders futile the conventional periodic transfer and termination of period (see for example FIG. 1).

Another advantage of the present invention, compared to the method and system from the prior art, is that it provides executives and managers with remote control over the business activities.

More specifically, a system and method for managing business activities, according to the present invention, allows management of employees, stocks, accounts, and any events that are accountable.

The control panel allows business managers and executives to foresee problems before they appear. The system allows them to be aware of any transaction the moment it is made.

Although the present invention has been described hereinabove by way of preferred embodiments thereof, it can be modified without departing from the spirit and nature of the subject invention, as defined in the appended claims.

What is claimed is:

1. A system for real-time management of business activities, the system comprising:
a business database including records; each of said records characterizing a business activity and including data entries; at least one of said records affecting at least one other of said records; and
a controller so configured as to:
a) receive a submission for a new data entry;
b) validate said new data entry, including associating said new data entry to a related record in said business database;
c) update each of said records that are affected by said related record; and
d) recursively repeat step c) for each of said affected records.

2. A system as recited in claim 1, further comprising a user database including information about at least one registered user of the system; said controller being further configured to allow connection thereto to said at least one registered user through a remote terminal; said controller being configured to receive new data entry submission from said remote terminal.

3. A system as recited in claim 2, wherein said controller is further configured in b) to prompt a confirmation to said registered user submitting said new data entry and to receive said confirmation therefrom before performing steps c) and d).

4. A system as recited in claim 3, wherein said controller is further configured in b) to store said new data entry submission before performing steps c) and d).

5. A system as recited in claim 4, wherein said controller is further configured in b) to advise at least one of said at least one registered user of said stored data entry submission if the processing of a new data entry from steps a) to d) is interrupted before the end of steps d).

6. A system as recited in claim 5, wherein one of said at least one advised registered user is the user that submitted said new data entry.

7. A system as recited in claim 5, wherein said controller is further configured in b) to prompt a confirmation to one of said at least one advised registered user and to receive said confirmation therefrom before performing steps c) and d).

8. A system as recited in claim 2, wherein said user database further comprises, for at least one registered user of the system, at least one predetermined alarm criteria for each of at least one selected record; said controller being further configured to e) display an alarm to each of said at least one registered user, whenever a data entry of said selected records corresponds to said at least one predetermined criteria of the corresponding user and to f) display on said corresponding user's terminal information indicative of said alarm.

9. A system as recited in claim 8, wherein said controller is further configured to display a control panel on said corresponding user's terminal; said control panel including a display field for each business activity characterized by said at least one selected records; said alarm being displayed in the form of a visual variation of the corresponding display field.

10. A system as recited in claim 9, wherein said controller is further configured so as to allow the personalization of said control panel.

11. A system as recited in claim 9, wherein said controller is further configured so as to update said control panel on said corresponding user's terminal at predetermined time.

12. A system as recited in claim 11, wherein said predetermined time is determined by said corresponding user.

13. A system as recited in claim 9, wherein said user database further comprises, for at least one registered user of the system, three predetermined alarm criteria; said alarms corresponding to each of said three predetermined criteria being displayed in the form of a different colour of the corresponding display field.

14. A system as recited in claim 13, wherein said three predetermined criteria being in the form of three thresholds for data entry values in said at least one selected record.

15. A system as recited in claim 14, wherein said different colors include red, yellow and green.

16. A system as recited in claim 2, wherein said controller is further configured to display information about at least one record to said at least one registered user through said corresponding remote terminal.

17. A system as recited in claim 16, wherein said displayed information includes time-variation of data entries in said at least one record.

18. A system as recited in claim 16, wherein said controller is further configured to update said record related information following a new data entry in said business database.

19. A system as recited in claim 16, wherein said information is presented in a form selected from the group consisting of a graph, a pie chart, and a bar chart.

20. A system as recited in claim 16, wherein said controller is further configured to simultaneously display information about a plurality of records.

21. A system as recited in claim 16, wherein said at least one record about which information is displayed is predetermined by said at least one registered user.

22. A system as recited in claim 2, wherein said controller is further configured to use data entries in said business database and user defined parameters to compute a forecast about at least one business activity.

23. A system as recited in claim 22, wherein said forecast is updated after said business database is updated in steps c) and d).

24. A system as recited in claim 2, wherein said controller is in the form of a computer server and said remote terminal is in the form of a personal computer connect to said server.

25. A system as recited in claim 1, wherein said controller being further configured to allow connection thereto to at least one direct-input device and to receive new data entry submission from said at least one direct input device.

26. A method in a computer system for real-time management of business activities, the method comprising:
providing a business database including records; each of said records characterizing a business activity and including data entries related to the business activity; at least one of said records affecting at least one other of said records; and
when a new data entry is submitted by a registered user,
a) validating said new data entry, including associating said new data entry to a related record in said business database;
b) updating each said record that are affected by said related record; and
c) recursively repeating step b) for each of said affected records;
whereby, each record that are directly or indirectly affected by another record are updated when a data entry is added in said other record.

27. A method as recited in claim 26, further comprising prompting a confirmation to said registered user submitting said new data entry and to receive said confirmation therefrom before performing steps b) and c).

28. A method as recited in claim 26, further comprising in a) temporarily storing said new data entry submission before performing steps b) and c);
whereby, loss of said new data entry is prevented, when an interruption occurs between steps a) and b) .

29. A method as recited in claim 26, further comprising d) triggering, for each of selected records, an alarm when at least one of the data entries of the selected record corresponds to at least one predetermined criteria and e) displaying information indicative of said alarm.

30. A method as recited in claim 26, wherein in e) said information indicative of said alarm is displayed on a control panel; said control panel including a display field for each of said business activities characterized by said selected records; said alarm being displayed in the form of a visual variation of the corresponding display field.

31. A method as recited in claim 26, further comprising f) displaying an operating panel including information related to at least one of said records.

32. A method as recited in claim 31, wherein said operating panel is updated following records update in said business database.
